(19) United States
(12) Patent Application Publication
(10) Pub. No.: US 2002/0023003 A1
(43) Pub. Date: Feb. 21, 2002

(54) Method and system of reselling in retail, preferred internet access services to the end user via a communications network

(76) Inventor: Fazal Syed Raheman, New Colony (IN)

Correspondence Address: Fazal Raheman, c/o IQ America, Inc., 3664 Rockbridge Rd., Stone Mountain, GA, 30083, US

(21) Appl. No.: 09/928,334

(22) Filed: Aug. 14, 2001

Related U.S. Application Data
(60) Provisional application No. 60/225,407, filed on Aug. 15, 2000.

(51) Int. Cl. G06F 17/60

(52) U.S. Cl. 705/14

(57) ABSTRACT

The invention describes a novel method and system of reselling in retail, preferred Internet access services to the end user at a subsidized cost through the use of a revenue generating interface, like an ad display interface, resident on the client machine. The end user will have the choice of ISP from the list of reseller's partner ISPs. The reseller would own a virtual super market of ISP services at a national or international level, also extending a ‘roaming’ facility to the subscriber when he is away from his primary point of access.

### BACKGROUND OF THE INVENTION

Internet is the fastest growing medium in the history. Internet advertising began in 1994, when the first banner ads were sold, and the first commercially available Web browser, Netscape Navigator 1.0, was released (November 1994). Within the next five year Internet advertising is projected to be a 30 billion dollar industry. In a recent study, the adoption rate of the Internet, was compared with the three other major “new media” invented this century: radio, network television and cable TV. While the TV and radio took 13 years and 38 years respectively to reach 50 million US users, the Internet achieved it in just 5 years. In 1950, Procter & Gamble spent less than 5% of its advertising dollars on television; the newest medium of the time. Five years later, it was committing 80% of its budgets to television.

Businesses are moving faster than ever to this brand new Internet medium. The Internet demographics are a marketer's dream. Net users are young, well educated and earn high incomes. Conventional browsers basically provide an interface between the user and the Web. An interface between the ISP and the user, will give the ISP exclusive pixel space to put it to revenue generating use. Whether the ISP revenue generating model is advertisement based or ecommerce based, an interface between the user and the ISP is an essential element of a free or subsidized ISP. Apart from such technological capabilities, an ISP should be big and strong enough to leverage major sponsorships to support their free ISP model. Brand loyalty is also a very important factor, which discourages a subscriber to move from his current Internet home to a new service provider. On account of such deficiencies many free ISPs have failed. My previous invention (U.S. patent application Ser. No. 09/589,522) provides ISP-specific connectivity to the user via an integrated ad display interface. However, it does not teach the means to let the users choose, or keep their current ISP, and still get sponsor subsidized Internet access through a single Internet access provider. The embodiments of the present invention are an improvement, which piggyback on the previous invention, and create an entirely new and unique business methodology, enabling a Web-based retail ISP Super Store for selling/reselling the range of branded ISP services to the end user at a substantially low price or completely free.

### BRIEF SUMMARY OF THE INVENTION

The embodiments of present invention enable an informed Internet user to pick and chose the ISP service of his choice and still get the service either free or at a substantially subsidized cost. Such a novel method and system enabling a virtual ISP Super Market (ISPSM) of preferred ISP services comprises of various modules at the following Nodes:

Node 1

Containing module 1 (M1)—An http compliant server application hosted on a remote server, comprising of a partner ISP database, the banner ads database with the ad targeting engine, and html pages for client machine interactions by the ISP subscribers, the advertisers and partner ISPs.

Node 2

Containing module 2 (M2)—An ISPSM controlled banner ad display or any model revenue generating software interface of prior art including but not limited to the one illustrated by me in a pending application. Such interface is a software application resident on the client machine.

Node 3

Containing module 3 (M3)—A network of partner ISP dial up terminal servers for the user selection, connectivity and account authentication.

Module 2 has been described in detail in the already cited pending application. Module 3 comprise of standard ISP terminal servers providing Internet connectivity to their subscribers. Module 1 is a Web based software application running on a remote network server providing user interactivity via a series of http-compliant user accessible web pages and comprising of:

A) a database of associated/partner ISPs

B) a banner ads database

C) a subscriber account opening page requesting user demographics

D) a preferred ISP location and selection page

E) a user ID page pointing to the preferred ISP terminal server for establishing new encrypted user ID for new subscriber, or for changing/encrypting the existing user ID for the current subscriber

F) a download for the online ad display GUI for the client machine installation

G) a customer account page providing the updated subscriber account information

H) a customer support page providing trouble shooting for the GUI of ISP reseller and link to the preferred ISP customer support for connectivity related trouble shooting

I) An unsubscribe page for account cancellation

J) Sponsor account access page providing link to a remote or integrated ad server for review of ad statistics and ad billing info.

K) An ad space auction page for advertisers, providing link to a remote or integrated ad auction site.

L) A site administration page for site and data updation

The aforementioned architecture of such an ISPSM is designed to apparently simulate the various departments of a Super Market on the World Wide Web in an html format as follows:

1. The Showroom

Off the shelf ISP inventory

Service registration

Software download

User name and encrypted password allocation

Check out

2. The Service

Connectivity provided directly by the chosen ISP.

User accesses the chosen ISP using only the ISPSM provided software interface to ensure sponsor displays.

3. The Billing

The ISPSM directly pays the ISP. The ISP delivers the payment credit statement to the subscriber.

4. Customer Support

The connectivity-related customer support is provided directly by the ISP.

GUI-related or change or cancellation services are provided by the ISPSM.

5. Partner Program Area

ISP support

Advertisers support

6. Banner ad auctions

Such a website functions as a virtual ISP Super Market of branded ISP services in discounts, each department is represented by a page. An Internet user walks into the ISP Super Market and looks for the brands of ISP services available at discount in his geographical location. He picks up his choice of ISP and completes the purchase of service, by submitting the service contract online. His user name and password is then authenticated by his choice of ISP from the ISPSM location itself. The user is then delivered the software online which enables his Internet access using his user name and password. Once user's account is set up with the new encrypted user ID, he can connect his preferred ISP using the prescribed software only. The user cannot access Internet using the conventional browser or dialer applications. This assures that sponsor displays, which enable the discounting of the Internet connectivity are not avoided. The ISPSM also provides online customer support department and different departments for the sponsors and advertisers and associate ISPs.

Accordingly, it is an object of the invention to enable the retailing of ISP services, just like any other commodity is sold through a retail store. Such ISP retailing is by means of reselling the branded ISP services at a price significantly lower than the published price.

It is also another object of the invention to enable connectivity between the ad displaying GUI of the client machine with a diversity of ISP terminal servers of the congregation of various affiliate ISPs.

It is yet another object of the invention to ensure the user connectivity to the ISP terminal server exclusively through the ad display GUI. It is still another object of the invention to enable inter-ISP roaming connectivity for the users away from their point of primary access.

It is still another object of the invention to provide single point comprehensive customer subscription and support services for the Internet subscribers and the advertisers.

### BRIEF DESCRIPTION OF THE DRAWING

FIG. 1 is a block diagram illustrating the three nodes of a preferred embodiment of the present invention.

### DETAILED DESCRIPTION OF THE INVENTION

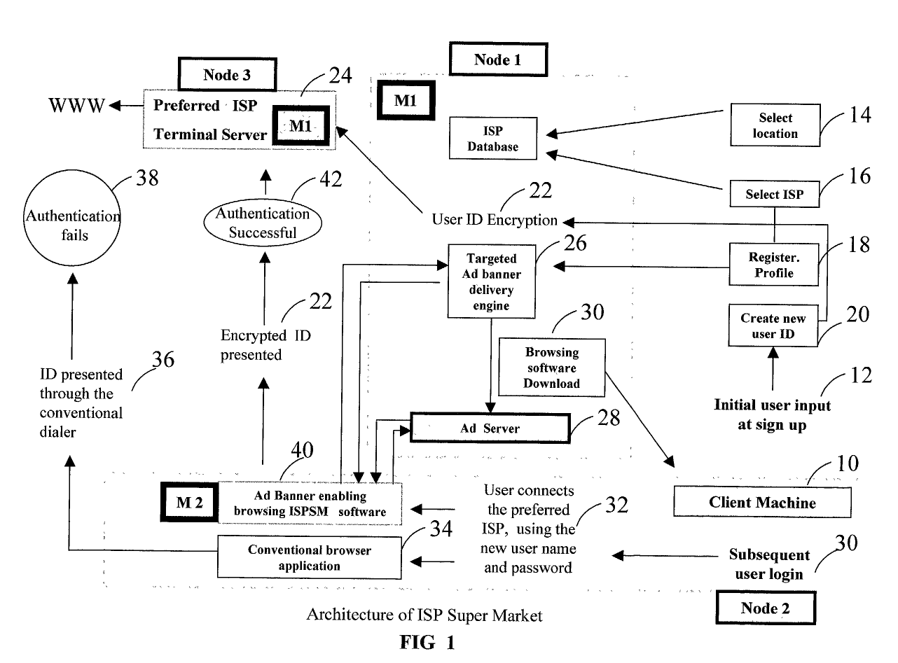

The preferred embodiment of the present invention is designed for a national or a multinational reseller of wide range of Internet access services of existing Internet Service Providers (ISPs) to the end user. The preferred embodiment is herein described in terms of construction of an ISP Super Market on the Web. As represented in FIG. 1, the preferred embodiment of the ISP Super Market (ISPSM) of the present invention is built up by integration of three nodes containing modules identified as M1, M2 and M3. The practical implementation of the invention begins with the Web connected client machine 10, accessing through any conventional browser, a URL address, which points to Web server, which hosts Module M2 of the present invention. The user interface of M2 provides a series of Web pages enabling a user's purchase of a preferred service. Customer sign up 12 is accomplished by the user first selecting the location 14 from where the service will be primarily accessed, followed by selection of the preferred ISP 16. The user then fills a service registration and agreement form 18, which allows to select a user name and password 20 to allow him to access the purchased service subsequently. The user ID so created by the user passes through the encryption engine 22 and creates the new user profile and an account in preferred ISP's subscriber database 24. If the user is already a current subscriber of the preferred ISP, the user profile is updated and user password is changed by assigning a new encrypted password. The user profile is stored at the remote Web server where the M1 Module of the present invention is hosted and processed by the targeted ad delivery engine 26, which interacts with the ad server 28 to execute the banner delivery to the specific user and accounting of the impressions of each banner served to specific groups of individual users.

For accessing the preferred ISP services the user downloads the browsing software 30 and installs on to the client machine 10. When the user connects to the preferred ISP 32 with the new user ID 20, using a conventional browser application 34 and a conventional dialer 36, the user is unable to log on to the preferred ISP terminal server 38. However, if the user uses the banner enabling software interface 40 downloaded from the M1 server, the encrypted ID 22 is presented to the preferred ISP terminal server, which authenticates the user and the login is successful 42.

Although the invention has been described in terms of a preferred embodiment, those skilled in the art will recognize that various modifications of the invention can be practiced within the spirit and scope of the appended claims. For example, the ad display browsing interface of Module 1 can be any other software interface capable of generating revenue, such as e-commerce portal, co-existing service displays such as TV, video, news etc. Also the client machine includes now only the user's personal computer, but any other Web compatible hardware and software, such as any remote PC at any location, a public access Internet Kiosk, Cyber Cafe terminal at any remote location can be a variation. Another variation of the preferred invention can be in the form of the various components of Module 1, being hosted on different Web servers, instead of a single Web application running from a single Web server.

Several embodiments of the present invention are specifically illustrated and described herein. However, it will be appreciated that modifications and variations of the present invention are covered by the above teachings. While the preferred embodiments of the present invention have been illustrated in detail, it should be apparent that modifications and adaptations to those embodiments may occur to one skilled in the art without departing from the scope of the present invention

What I claim as my invention is:

1. A novel method and system of reselling in retail, preferred Internet access services to the end user consisting of:
Node 1—ISP Super Market consisting of M1
Node 2—Subscriber end consisting of M2
Node 3—Preferred ISP Server consisting of M3

2. The method of claim 1 wherein node 2 is any client machine with Internet connectivity and Web browsing capability.

3. The method of claim 1 wherein node 2 carries a Web application which when accessed by node 1, provides choice of ISP that node 1 subscriber wishes to subscribe.

4. The method of claim 1 wherein node 3 is ISP server which authenticates the node 1 subscriber routed through node 2 reseller Web application.

5. The method of claim 1 wherein node 1 subscriber downloads ISP connectivity software from node 2 Web application server.

6. The method of claim 1 wherein subscriber of node 1 connects to the node 3 preferred ISP, by means of ad display interface at a subsidized cost.
